(19) United States
(12) Patent Application Publication
(10) Pub. No.: US 2003/0054309 A1
(43) Pub. Date: Mar. 20, 2003

(54) Oil tank thermal stability system

(76) Inventors: Joseph Henry King, Brick, NJ (US); Eric John Hermsen, Wall, NJ (US)

Correspondence Address: Eric Hermsen, 2093 Overbrook Drive, Wall, NJ, 07719, US

(21) Appl. No.: 10/225,848

(22) Filed: Aug. 22, 2002

Related U.S. Application Data
(60) Provisional application No. 60/314,539, filed on Aug. 24, 2001.

(51) Int. Cl. F23D 11/44; B60L 1/02

(52) U.S. Cl. 431/208; 219/205; 219/521

(57) ABSTRACT

A device that maintains the thermal stability for oil-fired heating systems with above ground oil storage tanks. This device maintains a system fluid temperature through a series of functions. When a thermal sensor detects a drop in fluid temperature in the above ground oil storage tank and the oil-fired heating system is operating, a switching device and temperature controller supplies heating power to the fluid heating coil. When a prescribed temperature of the fluid is achieved, the device deactivates until the next drop in fluid temperature is detected. The fluid temperature is maintained through the de-active cycle with a protective, thermally insulating oil tank blanket.

### BACKGROUND OF INVENTION

With the current changes in the oil heating industry and new mandates regarding underground oil storage tanks due to ground contamination, an unprecedented number of tanks are being removed from the ground. The customer is left with a choice of an above ground oil tank or converting to natural gas. If the person opts for the above ground oil tank, there is a concern with tank freezing or gelling due to condensation or the pour point of the oil. With the current invention in place, there is no need for the blending of fuels to lower pour points therefore saving the supplier as well as the customer added expense from the use of blended fuels, service calls and supplier/customer paid overtime. By eliminating the problems associated with pour point, fuel oil viscosity and firing the unit with cold oil the efficiency of the oil-fired heating unit is increased.

The problem with in-line fuel oil heater art currently is the focus is on the fuel oil in the gun and nozzle assembly. Problems exist in the above ground storage tank, if the fuel is gelled or frozen at the source it cannot be picked up by the fuel pump in the system, therefore the oil will can not be supplied to the gun and nozzle heaters. There are blended fuels and additives that have been used within the oil-fired heating industry which both will lower the heat content of the fuel oil but are expensive.

### SUMMARY OF THE INVENTION

The current invention is a controlled heating apparatus, which will monitor and raise the fluid temperature in the above ground tank when a sensor detects the drop in fluid temperature. The control is accomplished by a series of functions, which make the heating apparatus efficient to use and operate. The current invention is a system comprised of a controlled, electrically heated oil heating coil and a thermally insulating oil tank blanket. The system utilizes the fuel pump of the oil-fired unit and heating coil located on the return line for greater efficiencies. These efficiencies are achieved by keeping the coil filtered by the filter and strainer in the supply line and secondly by returning the oil back to the tank at a greater pressure, which allows for a better mixing of the heated oil with the colder oil. The coil is energized only when there is a “call for heat” from both the residential heating unit and the tank sensor. The coil is operated by a switching control device, which is connected to the primary control circuit of the heating unit. This switching control device utilizes one sensor, which is located on the supply line, and also has a low voltage function for temperature read-out and systems function on the indicator. The oil tank blanket ensures constant temperature of the oil through the non-heating cycles.

### DESCRIPTION OF THE DRAWINGS

FIG. 1 shows in schematic form the interaction of the components of the oil tank thermal stability system. The figure depicts the thermal sensor 1, switching control device 2, heating coil 3 and the oil tank 4;

FIG. 2 is an exploded view in perspective of the blanket 5.

### DETAILED DESCRIPTION OF THE INVENTION

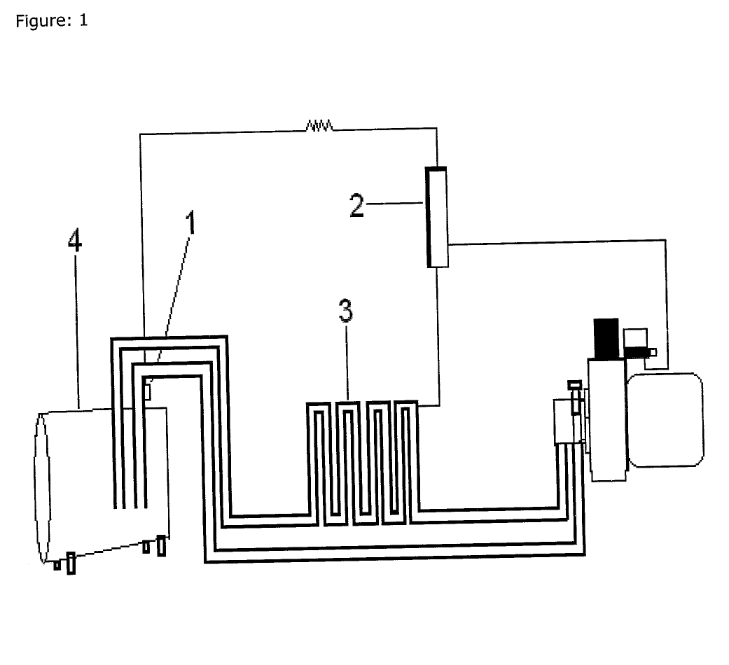

Detailed Functional Description of System (Referring to FIG. 1)

The fluid temperature falls below a prescribed temperature.

The thermal sensor 1 detects lower the temperature.

The switching control device 2 senses the temperature drop from thermal sensor 1.

The switching control device 2 closes the circuit sending power to the heating coil 3 (only if oil fired unit is active).

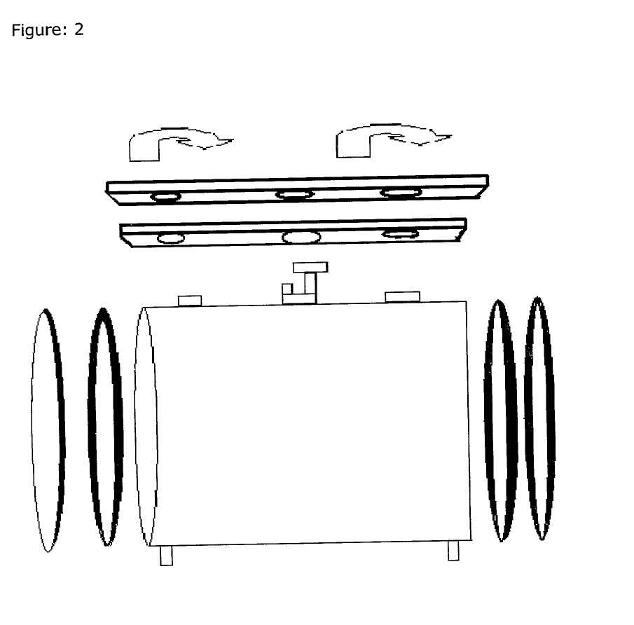

The heating coil 3 heats the fluid returning to the oil tank 4 that is covered with the insulated blanket 5 (referring now to FIG. 2 for blanket 5).

The heating coil 3 heats the fluid until either the oil fired unit becomes inactive or the thermal sensor 1 detects a fluid temperature at a prescribed level above fluid set temperature to eliminate cycling.

The switching control device 2 opens the circuit disconnecting power from the heating coil 3.

Detailed Description of the Components of the System

Referring to FIG. 2, the blanket 5 is thermally insulated. The blanket material is comprised of an insulating material such as Thinsulate™ and a weatherproof coating. The blanket also has cut outs to allow for oil tank legs, fill ports, etc. The components of the blanket can be attached at the oil tank with the use of hook and loop fasteners, snaps or straps. Weatherproof cones may be attached to the blanket at the top supply taps or fill ports at the top of the oil tank to ensure a weatherproof seal of the blanket to the oil tank.

Referring now to FIG. 1, the heating coil 3 is a device that heats the returning fluid to the oil tank. The heating coil 3 is comprised of fluid coil(s), heating element(s) and an insulated enclosure. The fluid coil(s) allow the returning fluid that passes through the heating coil 3 to be heated by the heating element(s). The heating element(s) heat the fluid in the fluid coil(s) and are thermally controlled by the switching control device. The enclosure houses the fluid coil(s) and heating element(s) along with insulation material to enable the heating coil 3 to efficiently heat the fluid in the fluid coil(s).

The thermal sensor 1 is installed on the incoming fluid line from the oil tank. The thermal sensor 1 is insulated from the ambient air and will change its electrical properties depending upon the fluid temperature. The switching control device 2 will utilize these electrical property differences to determine if fluid heating is necessary.

The switching control device 2 detects electrical information from the thermal sensor 1 to determine when heating coil 3 heater power is needed. The switching control device includes a line power circuit. This circuit may include a line power indicator light. The switching control device also contains a heating coil 3 heating element power feed. The power feed may include a heating element indicator light. The switching control device includes an adjustable temperature setting device with a fixed differential circuit to allow fluid temperature rise to a level above the temperature setting to alleviate heating element cycling.

We claim:

1. An oil-fired heating system oil tank thermal stability system comprising:
an oil tank insulating blanket comprised of one or more sections which may be fastened to an oil tank with a combination of hook and loop fasteners, snaps, straps or similar means.
a heating coil which is generally constructed of a plurality of tubular segments which are surrounded by one or more heating elements within an insulated enclosure. The enclosure would have inlet and outlet connection portions.
a temperature sensor with a means to sense the oil tank or oil inlet line oil temperature.
a switching control device firstly with an operable means to read the sensed oil tank or oil inlet line oil temperature, secondly an operable means to provide power to the heating coil heating elements, thirdly provide an operable means to override the prescribed oil temperature by use of an adjustable differential, and fourthly provide an operable means to perform a shut down function.

2. An oil-fired heating system oil tank thermal stability system comprising:
an oil tank insulating blanket comprised of one or more sections which may be fastened to an oil tank with a combination of hook and loop fasteners, snaps, straps or similar means.
an enclosure containing a heating coil, temperature sensor and switching control device where as the heating coil, which is generally constructed of a plurality of tubular segments, are surrounded by one or more heating elements within the insulated enclosure. The enclosure would have inlet and outlet connection portions. A temperature sensor with a means to sense the oil tank or oil inlet line oil temperature. A switching control device firstly with an operable means to read the sensed oil tank or oil inlet line oil temperature, secondly an operable means to provide power to the heating coil heating elements, thirdly provide an operable means to override the prescribed oil temperature by use of an adjustable differential, and fourthly provide an operable means to perform a shut down function.

3. An oil tank insulating blanket comprised of one or more sections which may be fastened to an oil tank with a combination of hook and loop fasteners, snaps, straps or similar means. The blanket may be constructed of a Thinsulate™ type of material.
